(19) United States
(12) Patent Application Publication
(10) Pub. No.: US 2025/0392508 A1
(43) Pub. Date: Dec. 25, 2025

(54) METHODS AND SYSTEMS FOR LEVERAGING A DYNAMIC HOST CONFIGURATION PROTOCOL (DHCP) RELAY AGENT (RA) TO OBTAIN ZERO-TOUCH PROVISIONING (ZTP) FAILURE INFORMATION

(71) Applicant: CIENA CORPORATION, Hanover, MD (US)

(72) Inventors: Alex Banc, Ottawa (CA); Cheng Peng, Nepean (CA)

(73) Assignee: CIENA CORPORATION, Hanover, MD (US)

(21) Appl. No.: 18/751,777

(22) Filed: Jun. 24, 2024

(51) Int. Cl. H04L 41/0686; H04L 43/0823

(52) U.S. Cl. CPC H04L 41/0686; H04L 43/0823

(57) ABSTRACT

Aspects of the subject disclosure may include, for example, receiving a Dynamic Host Configuration Protocol (DHCP) message from a network element (NE), wherein the DHCP message includes information relating to a zero-touch provisioning (ZTP) failure, and performing one or more actions to extract the information from the DHCP message and to store the information for access by one or more other devices or systems. Other embodiments are disclosed.

### FIELD OF THE DISCLOSURE

The subject disclosure relates to leveraging a Dynamic Host Configuration Protocol (DHCP) Relay Agent (RA) to obtain Zero-Touch Provisioning (ZTP) failure information.

### BACKGROUND

ZTP is a method in which a network element (NE) automatically configures itself during start-up or boot-up for the very first time. This involves automatic fetching and loading of provisioning information, including system software, patch files, and configuration files. DHCP is a network protocol that assigns Internet Protocol (IP) addresses and provides network settings to NEs, which the NEs can use to facilitate ZTP. DHCPv6 is a version of DHCP that assigns Internet Protocol version 6 (IPv6) addresses and provides network settings to NEs, which the NEs can use to facilitate ZTP. A DHCP client is an NE that requests network configuration from a DHCP server via IPv4 and/or IPv6 networks. A DHCP RA is an NE that forwards DHCP and/or DHCPv6 messages between clients and servers.

### BRIEF DESCRIPTION OF THE DRAWINGS

Reference will now be made to the accompanying drawings, which are not necessarily drawn to scale, and wherein:

FIG. 1 illustrates an example system and associated process flows in which a DHCP RA is used to enable a DHCP process between a DHCP server and an NE for facilitating ZTP.

FIG. 2A illustrates an example system and associated process flows in which ZTP failure information is reported by an NE to a DHCP RA as part of DHCP negotiation and extracted by the DHCP RA for storage/access, in accordance with various aspects described herein.

FIG. 2B illustrates an example flowchart relating to extraction/providing of ZTP failure information by a DHCP RA, in accordance with various aspects described herein.

FIG. 3A depicts an illustrative embodiment of a method in accordance with various aspects described herein.

FIG. 3B depicts an illustrative embodiment of another method in accordance with various aspects described herein.

FIG. 3C depicts an illustrative embodiment of a yet another method in accordance with various aspects described herein.

FIG. 4 is a block diagram of an example, non-limiting embodiment of a computing environment in accordance with various aspects described herein.

### DETAILED DESCRIPTION

For a DHCP client or a DHCPv6 client (which may be generally referred to herein as simply DHCP client) to obtain an IP address and other network settings from a DHCP server, they typically need to reside within the same Layer 2 network. However, this arrangement may not always be feasible in practice. To overcome this limitation, the DHCP RA was introduced to act as an intermediary by forwarding DHCP-related packets between the DHCP server and the DHCP client so that they can engage in the DHCP process despite being on separate networks.

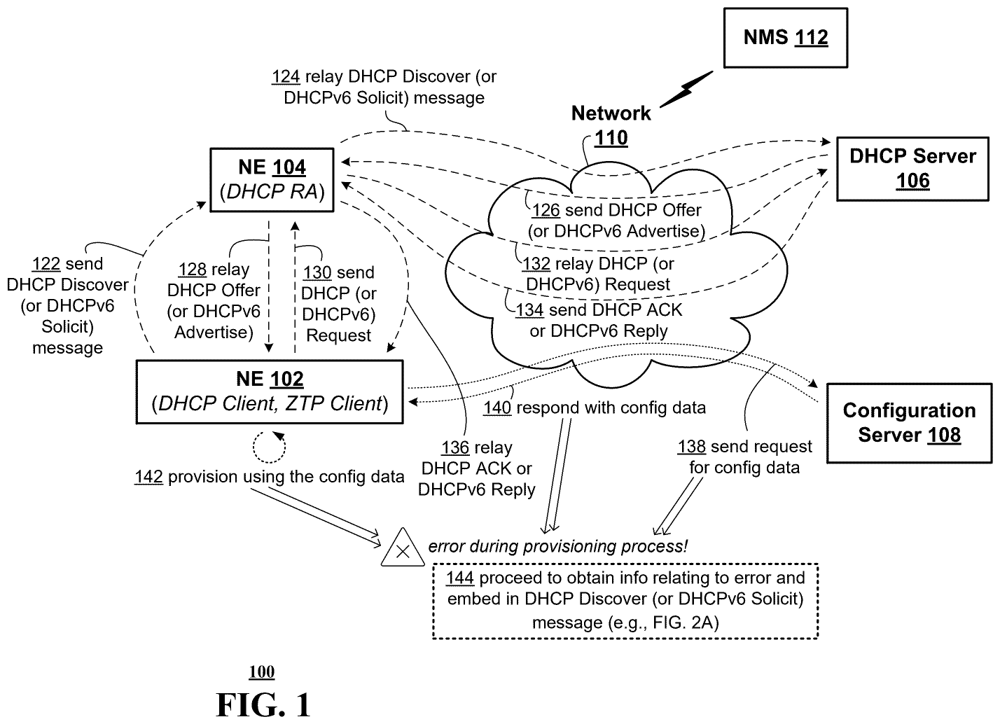

FIG. 1 illustrates an example system 100 and associated process flows in which a DHCP RA is used to enable a DHCP process between a DHCP server and an NE for facilitating ZTP. As shown in FIG. 1, the system 100 may include an NE 102, an NE 104, a DHCP server 106, a configuration server 108, a network 110, and a network management system (NMS) 112.

The NE 102 may be a network device, such as a switch, a hub, a router, a bridge, or any other network device that is configured to perform one or more network-related functions, including, for instance, receiving data packets from other NEs, processing data packets, forwarding data packets to other NEs, and so on. In this context, the NE 102 may be configured with a DHCP client and a ZTP client.

The NE 104 may be a network device that is similar to the NE 102, but that is configured to act as a DHCP RA. The NE (or DHCP RA) 104 may be communicatively coupled to one or more clients (e.g., the NE 102 and/or other NEs) via local connection(s), and is capable of forwarding DHCP or DHCPv6 messages between the DHCP server 106 and those client(s). The DHCP RA 104 may be configured as a Transmission Control Protocol/IP (TCP/IP) host, and may store IP addresses of the DHCP server 106 as well as other DHCP servers (not shown) and use those IP addresses for relaying DHCP or DHCPv6 messages. The DHCP RA 104 may be capable of performing additional functions, such as, for instance, DHCP packet filtering, rate limiting, and/or access control.

The DHCP server 106 may be configured to manage the DHCP or DHCPv6 service for NEs by assigning/providing IP addresses and network settings (e.g., subnet masks, default gateways, configuration server locations/addresses, etc.) to the NEs. The DHCP server 106 may be implemented in one or more dedicated hardware devices, one or more virtual machines, or one or more software components that run on server(s) or a cloud infrastructure.

The configuration server 108 may store configuration files and data for facilitating ZTP for NEs. The configuration server 108 may be implemented in one or more dedicated hardware devices, one or more virtual machines, or one or more software components that run on server(s) or a cloud infrastructure.

The network 110 may include any type of network (or data connection network (DCN)), such as a local area network (LAN), a wide area network (WAN), or an Internet. The network 110 may include wired and/or wireless connections, such as Ethernet, Wi-Fi, cellular networks, and so on. In some implementations, the network 110 may include a private network or a public network that spans various geographic areas.

The NMS 112 may be configured to monitor and provide overall management for some or all of the devices (e.g., NEs 102, 104, etc.) associated with the network 110. The NMS 112 may obtain various data or metrics relating to the operations/statuses of these devices to facilitate issue detection and maintenance actions for ensuring optimal or near-optimal network operations. The NMS 112 may be implemented in software, a hardware device, or in a cloud-based infrastructure, and may be integrated with one or more other management systems.

At step 122 in FIG. 1, the NE 102 may send a DHCP Discover (or DHCPv6 Solicit) message to the DHCP RA 104. At step 124, the DHCP RA 104 may relay the message to the DHCP server 106 over the network 110. The DHCP server 106 may respond with a DHCP Offer (or DHCPv6 Advertise) at step 126, which provides the NE 102 with an available IP address and other network settings. At step 128, the DHCP Offer (or DHCPv6 Advertise) may be relayed from the DHCP RA 104 to the NE 102. At step 130, the NE 102 may send a DHCP (or DHCPv6) Request to the DHCP RA 104, requesting the offered/advertised IP address and network settings. At step 132, the DHCP RA 104 may relay this request to the DHCP server 106, after which the DHCP server 106 may, at step 134, send a DHCP ACK (acknowledgment) (or DHCPv6 Reply) to the DHCP RA 104 as a confirmation of the assignment of the IP address and network settings to the NE 102. At step 136, the DHCP RA 104 may relay this confirmation to the NE 102, thereby completing the DHCP process. As a result of the foregoing steps, the NE 102 may obtain appropriate network settings that it can use to communicate over the network 110 with the configuration server 108 for ZTP purposes. Particularly, the NE 102 may, at step 138, send a request for configuration data to the configuration server 108 over the network 110. At 140, the configuration server 108 may respond to the NE 102 with the configuration data, and at 142, the NE 102 may provision itself using that configuration data.

It is possible for a ZTP process to fail-e.g., during any of steps 138, 140, and 142 described above. When the ZTP client encounters a failure during the ZTP process, the DHCP client restarts the DHCP process in order to allow ZTP to be attempted again. Some common reasons for failure include missing or corrupted configuration/boot files in the configuration server 108, network connectivity issues with the configuration server 108, incorrect/missing authentication credentials for accessing the configuration server 108, connection timeouts, and so on. In existing implementations according to current DHCP-related standards, the ZTP client in an NE is simply not equipped to report failures, whether to an external user, an NMS, or otherwise. In all, a network administrator may be left guessing as to where and why the ZTP process failed, which can result in undue system downtime and troubleshooting efforts.

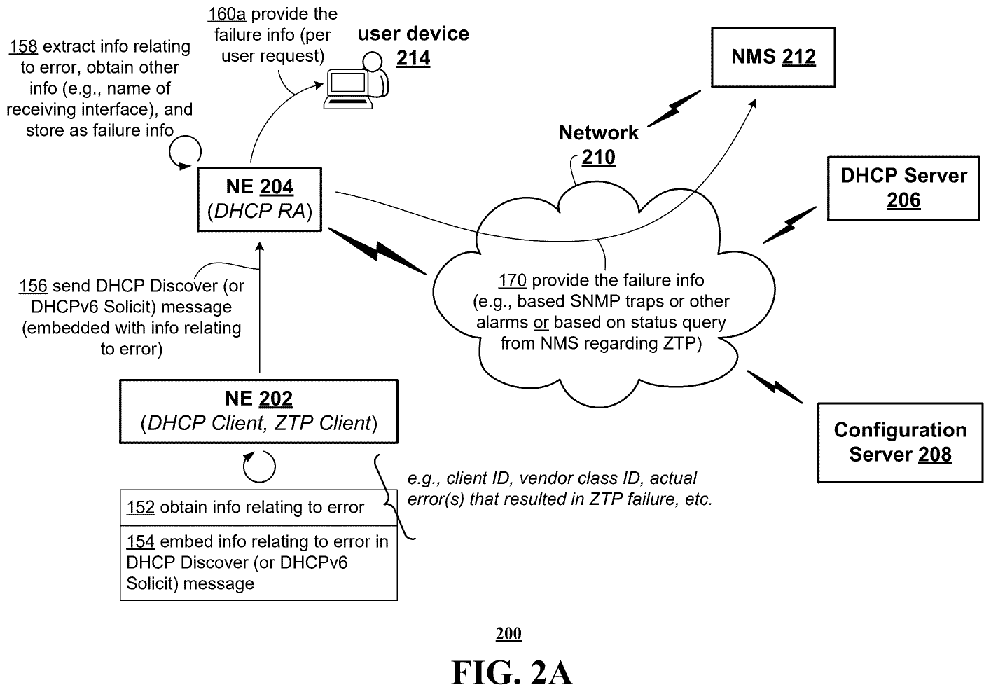

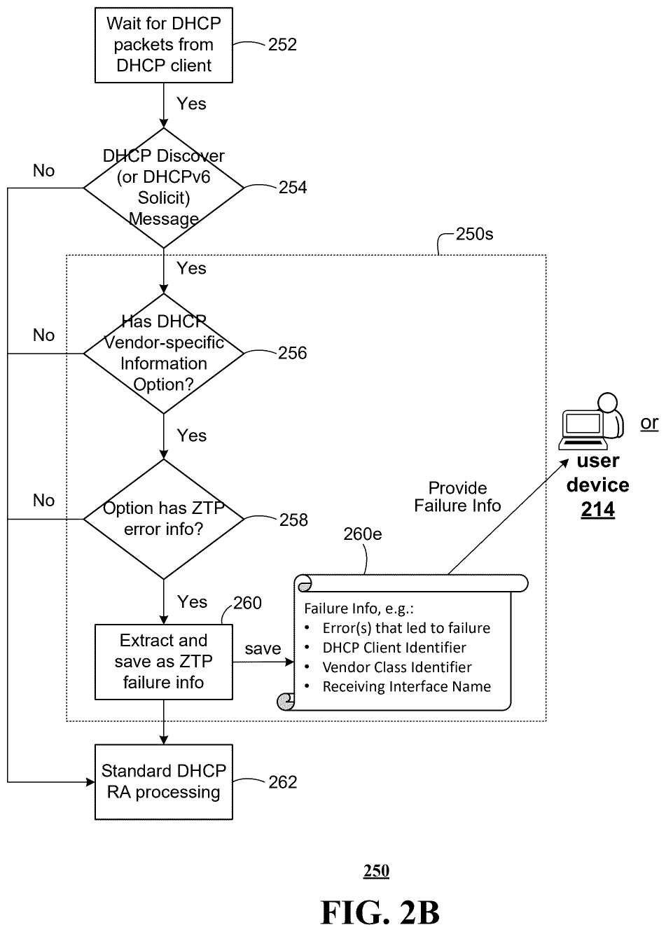

The subject disclosure describes, among other things, illustrative embodiments for leveraging a DHCP RA to obtain information relating to ZTP failures. In exemplary embodiments, an NE may be capable of embedding or inserting ZTP failure information into a DHCP-related message for transmission in a subsequent DHCP negotiation after the failure (e.g., see reference number 144 in FIG. 1, where the NE 102 may proceed to obtain info relating to the error and embed the info in a DHCP Discover (or DHCPv6 Solicit) message (described in more detail below with respect to FIG. 2A)). The ZTP failure information may include, for instance, the reason of the failure (e.g., the actual error that occurred), a client identifier of the NE, and/or a vendor class identifier associated with the NE. In one or more embodiments, the DHCP-related message may be a DHCPv4 Discover message. In other embodiments, the DHCP-related message may alternatively be a DHCPv6 Solicit message. The ZTP failure information may be embedded or inserted into any usable field or option in the DHCP-related message, such as, for instance, the vendor-specific information option. In any case, the DHCP RA may, based upon receiving the DHCP-related message from the NE, detect and extract or decode the embedded or inserted information for storage and/or reporting to one or more devices or systems.

Modifying the existing standard DHCP-related operations in the NE and/or the DHCP RA, as described herein, provides for debugging capabilities for indirect ZTP failures. A user or an NMS may, based on obtaining the ZTP failure information, easily identify the failures, which can facilitate issue resolution. Various aspects of ZTP failure reporting and/or error extraction described herein may be incorporated into one or more standards, such as, for instance, Request for Comment (RFC) 2131 Dynamic Host Configuration Protocol, RFC 8415 Dynamic Host Configuration Protocol for IPv6 (DHCPv6), and/or one or more other DHCP-related standards.

One or more aspects of the subject disclosure include an apparatus, comprising one or more processors, and a memory that stores executable instructions that, when executed, cause the one or more processors to perform operations. The operations can include obtaining information relating to a zero-touch provisioning (ZTP) failure. The operations can further include embedding the information in a Dynamic Host Configuration Protocol (DHCP) message, resulting in a modified DHCP message.

One or more aspects of the subject disclosure include a device, comprising one or more processors, and a memory that stores executable instructions that, when executed, cause the one or more processor to perform operations. The operations can include receiving a Dynamic Host Configuration Protocol (DHCP) message from a network element (NE), wherein the DHCP message includes information relating to a zero-touch provisioning (ZTP) failure. The operations can further include performing one or more actions to extract the information from the DHCP message and to store the information for access by one or more other devices or systems.

One or more aspects of the subject disclosure include a non-transitory machine-readable medium, comprising executable instructions that, when executed by a processing system including a processor, facilitate performance of operations. The operations can include at least one of receiving a user command to query a device for information relating to one or more zero-touch provisioning (ZTP) failures, or configuring the device to monitor Dynamic Host Configuration Protocol (DHCP) messages for the information. The operations can further include obtaining the information from the device based on the at least one of the receiving or the configuring.

Other embodiments are described in the subject disclosure.

FIG. 2A illustrates an example system 200 and associated process flows in which ZTP failure information is reported by a device to a DHCP RA as part of DHCP negotiation and extracted by the DHCP RA for storage/access, in accordance with various aspects described herein. As shown in FIG. 2A, the system 200 may include an NE 202, an NE (or DHCP RA) 204, a DHCP server 206, a configuration server 208, a network 210, and an NMS 212. These devices/systems may respectively correspond to (or may be respectively similar to) the NE 102, the NE (or DHCP RA) 104, the DHCP server 106, the configuration server 108, the network 110, and the NMS 112 described above with respect to FIG. 1, and thus the general descriptions of these devices/systems will not be repeated for the sake of brevity. However, functionalities that facilitate ZTP failure reporting will be described below.

For instance, in one or more embodiments, the NE 202 may be configured with one or more functionalities for obtaining information relating to a ZTP failure, and embedding that information in a DHCP Discover (or DHCPv6 Solicit) message for transmission in a (e.g., subsequent) DHCP negotiation process. In various embodiments, the DHCP RA 204 may be configured with one or more functionalities for extracting the ZTP failure information from the DHCP Discover (or DHCPv6 Solicit) message and storing/reporting the information to a user device 214 or the NMS 212.

At 152 in FIG. 2A, the NE 202 may, based upon experiencing a failure in the ZTP process (e.g., such as that described above with respect to steps 138, 140, and/or 142 of FIG. 1), obtain information relating to the failure. In exemplary embodiments, the information may include a client identifier (ID) of the NE 202, a vendor class ID (e.g., serial number, product type, etc.) associated with the NE 202, or a combination thereof. In various embodiments, the information may additionally include the actual error(s) that resulted in the failure.

At 154, the NE 202 may embed the information relating to the failure in a DHCP Discover (or DHCPv6 Solicit) message. For instance, the ZTP client in the NE 202 may, based upon detecting the failure, obtain the information and either embed the information in the DHCP Discover (or DHCPv6 Solicit) message or cause the DHCP client to do so. Alternatively, the DHCP client in the NE 202 may, based upon detecting an indication of the failure from the ZTP client, obtain the information from the ZTP client, and embed the information in the DHCP Discover (or DHCPv6 Solicit) message. In one or more embodiments, the information relating to the failure may be included in one or more options in the DHCP Discover (or DHCPv6 Solicit) message, such as the Client Identifier option, the Class Identifier option, and/or the Vendor-specific information option. For instance, the client ID of the NE 202 may be included in the Client Identifier option in the DHCP Discover (or DHCPv6 Solicit) message, the vendor class ID associated with the NE 202 may be included in the Class Identifier option in the DHCP Discover (or DHCPv6 Solicit) message, and the error(s) that resulted in the failure may be included in the Vendor-specific information option in the DHCP Discover (or DHCPv6 Solicit) message.

At 156, the NE 202 may send the DHCP Discover (or DHCPv6 Solicit) message (embedded with the ZTP failure information) to the DHCP RA 204. At 158, the DHCP RA 204 may extract the information relating to the failure from the DHCP Discover (or DHCPv6 Solicit) message, and may store that information in one or more data structures (e.g., databases, lists, etc.) and/or make the information accessible to a querying user device 214, the NMS 212, or both. In various embodiments, the DHCP RA 204 may additionally obtain (and store and/or make accessible to a querying user device 214, the NMS 212, or both) the name of the receiving interface that the DHCP RA 204 used to receive the DHCP Discover (or DHCPv6 Solicit) message. Such information can be especially helpful in cases where the DHCP RA 204 has numerous interfaces and needs to serve numerous clients.

In one or more embodiments, the DHCP RA 204 may be configured to monitor incoming DHCP Discover (or DHCPv6 Solicit) messages for ZTP failure information or to monitor the data structure for newly-added ZTP failure information, and to provide the ZTP failure information either automatically or upon request. As an example, the DHCP RA 204 may be communicatively coupled to a user device 214 over a local connection, and may receive requests from the user device 214 (e.g., submitted based on user command(s) inputted via a command line interface or the like) to provide the ZTP failure information. In this example, the DHCP RA 204 may respond to a given request by transmitting (160a) a portion or an entirety of the ZTP failure information to the user device 214.

As another example, the DHCP RA 204 may be configured to automatically transmit (170) notifications regarding ZTP failures to the NMS 212 based on one or more criteria being met. The DHCP RA 204 may be configured to do so by way of traps (e.g., Simple Network Management Protocol (SNMP) traps) or other types of alarms, which may be set based on user command(s). In various embodiments, the criteria may be the detection of ZTP failure information in an incoming DHCP Discover (or DHCPv6 Solicit) message and/or the detection of a change in the state of the data structure (e.g., the addition of ZTP failure information in the data structure). Certain thresholds may also be set for the criteria, such that, for instance, a notification is transmitted (e.g., only) if multiple ZTP failures are detected within a threshold period of time or (e.g., only) if three or more entries of ZTP failure information have been added to the data structure within a threshold period of time.

As yet another example, the NMS 212 may be configured (e.g., based on user command(s)) to poll or query the DHCP RA 204 for status on ZTP. In this example, the DHCP RA 204 may respond to the NMS 212 with (e.g., any) ZTP failure information that has been extracted or obtained. In some implementations, the provided information may (e.g., only) include ZTP failure information that has been extracted or obtained since a prior poll or query was previously received from the NMS 212. For instance, if a prior poll or query was responded to with a first set of ZTP failure information (e.g., relating to one or more NEs), if a second set of ZTP failure information (e.g., relating to one or more NEs) has since been extracted or obtained, and if a new poll or query is now received from the NMS 212, the DHCP RA 204 may respond to the NMS 212 either with both the first and second sets of ZTP failure information or only with the second set of ZTP failure information.

In cases where the NMS 212 obtains ZTP failure information from the DHCP RA 204, the NMS 212 may utilize such information to facilitate one or more of its management/maintenance operations. For instance, the NMS 212 may leverage artificial intelligence (AI)/machine learning (ML) to analyze the information, detect failure patterns, make predictions of future failures, and/or make recommendations on steps that can be taken to avoid future failures.

FIG. 2B illustrates an example flowchart 250 relating to extraction/providing of ZTP failure information by a DHCP RA, in accordance with various aspects described herein. The DHCP RA may, for example, correspond to the DHCP RA 204 of FIG. 2A. The dotted boundary box 250s represents additional steps or functions that can be incorporated or adapted into existing standard(s) that define DHCP RA processing. At 252, the DHCP RA may wait for DHCP packets from a DHCP client. For instance, the NE 202 may be configured with a DHCP client as well as a ZTP client. At 254, the DHCP RA may determine whether a DHCP Discover (or DHCPv6 Solicit) message is received from the DHCP client. If the DHCP RA determines that no DHCP Discover (or DHCPv6 Solicit) message has been received from the DHCP client (No), the DHCP RA may proceed to step 262 to perform standard or typical DHCP RA processing, such as that currently defined in one or more DHCP-related standards. If, on the other hand, the DHCP RA determines that a DHCP Discover (or DHCPv6 Solicit) message has been received from the DHCP client (Yes), the DHCP RA may, at 256, determine whether the Vendor-specific information option in the DHCP Discover (or DHCPv6 Solicit) message is present or selected. If the DHCP RA determines that the Vendor-specific information option in the DHCP Discover (or DHCPv6 Solicit) message is not present or not selected (No), the DHCP RA may proceed to step 262 to perform the standard or typical DHCP RA processing. If, on the other hand, the DHCP RA determines that the Vendor-specific information option in the DHCP Discover (or DHCPv6 Solicit) message is present or is selected (Yes), the DHCP RA may, at 258, determine whether the option includes or is associated with ZTP failure information. If the DHCP RA determines that the option does not include or is not associated with ZTP failure information, the DHCP RA may proceed to step 262 to perform the standard or typical DHCP RA processing. If, on the other hand, the DHCP RA determines that the option does include or is associated with ZTP failure information, the DHCP RA may, at 260, extract the ZTP failure information from the DHCP Discover (or DHCPv6 Solicit) message. The DHCP RA may record (260c) the ZTP failure information (e.g., in one or more data structures) and/or provide such information to the user device 214 and/or the NMS 212 (e.g., based upon a user request, based on previously-set traps, etc., as described above with respect to FIG. 2A). The extraction may involve extraction of a client ID from a Client Identifier option in the DHCP Discover (or DHCPv6 Solicit) message, extraction of a vendor class ID from a Class Identifier option in the DHCP Discover (or DHCPv6 Solicit) message, extraction of actual error(s) that resulted in the failure from the Vendor-specific information option in the DHCP Discover (or DHCPv6 Solicit) message, or a combination thereof. In some implementations extraction of the vendor class ID may be optional, particularly in cases where a vendor (e.g., a user or administrator) is able to identify the relevant NE based on the client ID. In various embodiments, the DHCP RA may also record (260e) the name of the receiving interface where the DHCP Discover (or DHCPv6 Solicit) message was received.

It is to be understood and appreciated that, while various embodiments are described herein as relating to particular versions of DHCP, such as DHCPv4 and DHCPv6, the exemplary method(s)/system(s) may apply to any version of DHCP.

It is also to be understood and appreciated that, although one or more of FIGS. 2A and 2B might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various systems, devices, network elements, servers, etc. may have been illustrated in one or more of FIGS. 2A and 2B as separate systems, devices, network elements, servers, etc., it will be appreciated that multiple systems, devices, network elements, servers, etc. can be implemented as a single system, device, network element, server, etc., or a single system, device, network element, server, etc. can be implemented as multiple systems, devices, network elements, servers, etc. Additionally, functions described as being performed by one system, device, network element, server, etc. may be performed by multiple systems, devices, network elements, servers, etc., or functions described as being performed by multiple systems, devices, network elements, servers, etc. may be performed by a single system, device, network element, server, etc.

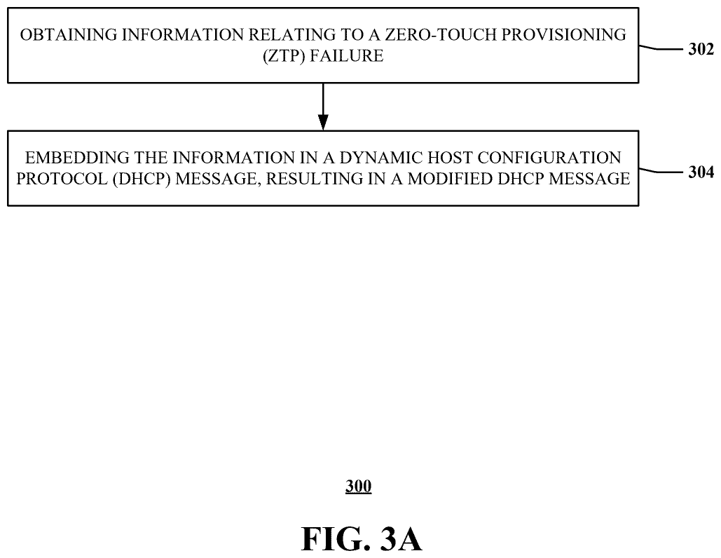

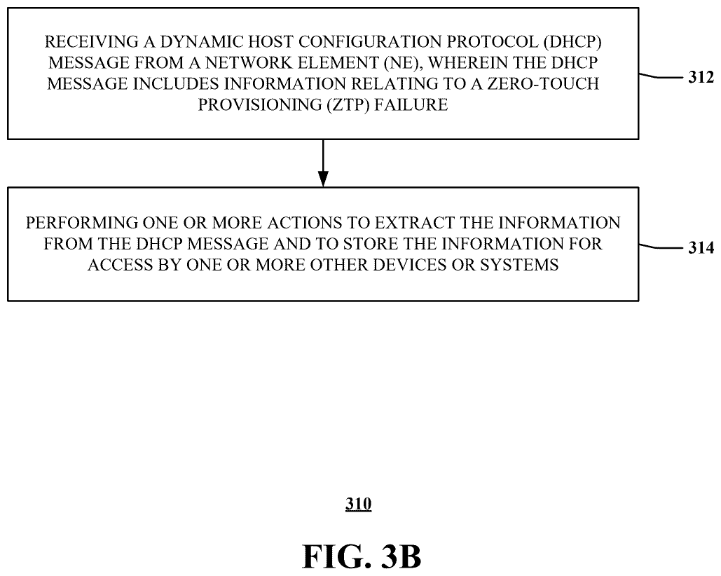

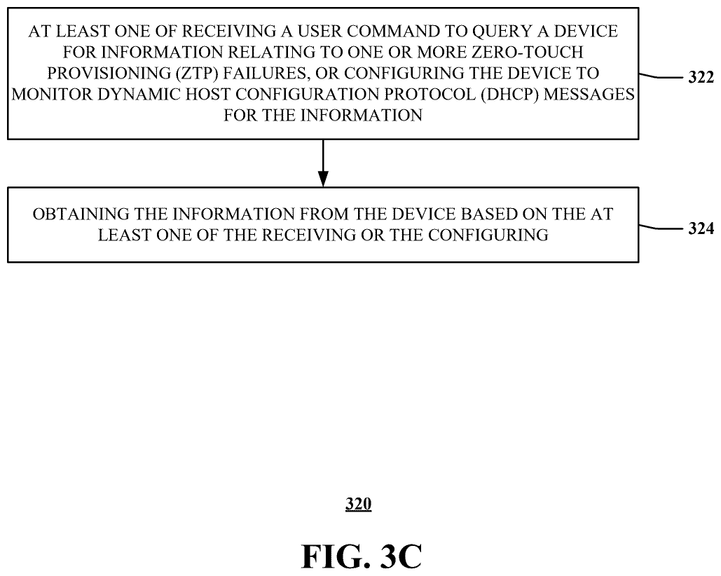

FIG. 3A depicts an illustrative embodiment of a method 300 in accordance with various aspects described herein.

At 302, the method can include obtaining information relating to a zero-touch provisioning (ZTP) failure. For example, the NE 202 can, similar to that described above with respect to one or more of FIGS. 2A and 2B, perform one or more operations that include obtaining information relating to a ZTP failure.

At 304, the method can include embedding the information in a Dynamic Host Configuration Protocol (DHCP) message, resulting in a modified DHCP message. For example, the NE 202 can, similar to that described above with respect to one or more of FIGS. 2A and 2B, perform one or more operations that include embedding the information in a DHCP message, resulting in a modified DHCP message.

While for purposes of simplicity of explanation, the respective processes are shown and described as a series of blocks in FIG. 3A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 3B depicts an illustrative embodiment of a method 310 in accordance with various aspects described herein.

At 312, the method can include receiving a Dynamic Host Configuration Protocol (DHCP) message from a network element (NE), wherein the DHCP message includes information relating to a zero-touch provisioning (ZTP) failure. For example, the DHCP RA 204 can, similar to that described above with respect to one or more of FIGS. 2A and 2B, perform one or more operations that include receiving a DHCP message from an NE, wherein the message includes information relating to a ZTP failure.

At 314, the method can include performing one or more actions to extract the information from the DHCP message and to store the information for access by one or more other devices or systems. For example, the DHCP RA 204 can, similar to that described above with respect to one or more of FIGS. 2A and 2B, perform one or more operations that include performing one or more actions to extract the information from the DHCP message and to store the information for access by one or more other devices or systems.

While for purposes of simplicity of explanation, the respective processes are shown and described as a series of blocks in FIG. 3B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 3C depicts an illustrative embodiment of a method 320 in accordance with various aspects described herein.

At 322, the method can include at least one of receiving a user command to query a device for information relating to one or more zero-touch provisioning (ZTP) failures, or configuring the device to monitor Dynamic Host Configuration Protocol (DHCP) messages for the information. For example, the NMS 212 can, similar to that described above with respect to one or more of FIGS. 2A and 2B, perform one or more operations that include at least one of receiving a user command to query a device for information relating to one or more ZTP failures, or configuring the device to monitor DHCP messages for the information.

At 324, the method can include obtaining the information from the device based on the at least one of the receiving or the configuring. For example, the NMS 212 can, similar to that described above with respect to one or more of FIGS. 2A and 2B, perform one or more operations that include obtaining the information from the device based on the at least one of the receiving or the configuring.

While for purposes of simplicity of explanation, the respective processes are shown and described as a series of blocks in FIG. 3C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

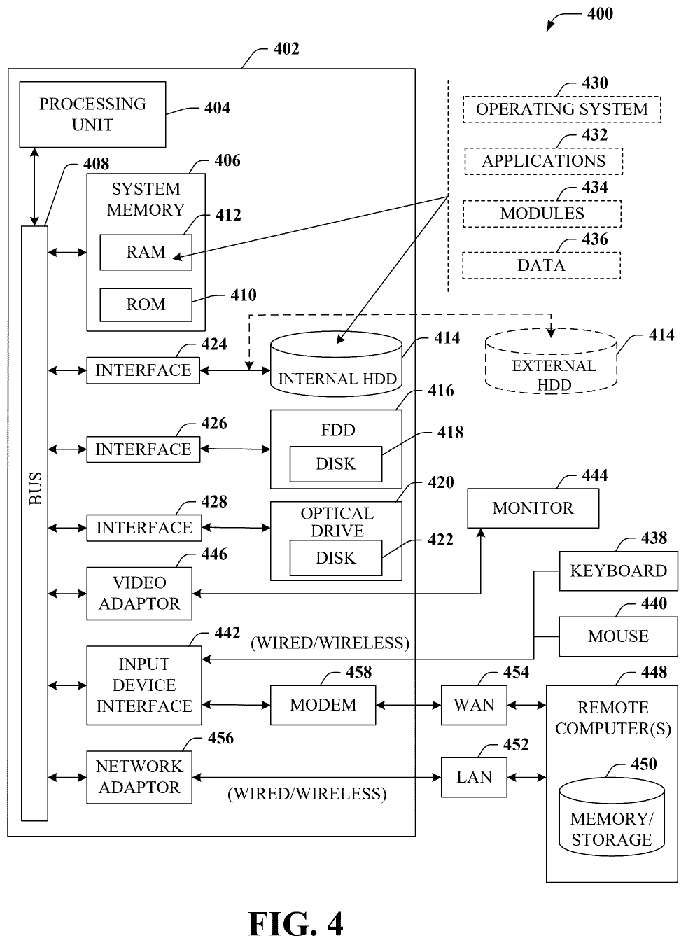

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, the computing environment 400 can be used in computing device described herein. Each of these devices can be implemented via computer-executable instructions that can run on one or more computers, and/or in combination with other program modules and/or as a combination of hardware and software. For example, computing environment 400 can facilitate in whole or in part leveraging a DHCP RA to obtain information relating to ZTP failures. Further, one or more of the devices/components/systems in FIGS. 1, 2A, and/or 2B may include computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f (x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. An apparatus, comprising:
one or more processors; and
a memory that stores executable instructions that, when executed, cause the one or more processors to
obtain information relating to a zero-touch provisioning (ZTP) failure, and
embed the information in a Dynamic Host Configuration Protocol (DHCP) message, resulting in a modified DHCP message.

2. The apparatus of claim 1, wherein the apparatus comprises a DHCP client, and wherein one or more of the obtaining and the embedding are performed by the DHCP client.

3. The apparatus of claim 1, wherein the apparatus comprises a ZTP client, and wherein one or more of the obtaining and the embedding are performed by the ZTP client.

4. The apparatus of claim 1, wherein the instructions, when executed, further cause the one or more processors to transmit the modified DHCP message to a DHCP Relay Agent (RA).

5. The apparatus of claim 1, wherein the information comprises a client identifier, a vendor class identifier, information regarding one or more errors that resulted in the ZTP failure, or a combination thereof.

6. The apparatus of claim 1, wherein the DHCP message comprises a DHCPv4 Discover message or a DHCPv6 Solicit message.

7. The apparatus of claim 1, wherein the embedding comprises embedding at least a portion of the information in a Vendor-specific information option in the DHCP message.

8. The apparatus of claim 1, wherein the instructions, when executed, further cause the one or more processors to detect the ZTP failure, and wherein the obtaining is responsive to the detecting.

9. A device, comprising:
one or more processors; and
a memory that stores executable instructions that, when executed, cause the one or more processors to
receive a Dynamic Host Configuration Protocol (DHCP) message from a network element (NE), wherein the DHCP message includes information relating to a zero-touch provisioning (ZTP) failure, and
perform one or more actions to extract the information from the DHCP message and to store the information for access by one or more other devices or systems.

10. The device of claim 9, wherein the device comprises a DHCP Relay Agent (RA).

11. The device of claim 9, wherein the information comprises a client identifier, a vendor class identifier, information regarding one or more errors that resulted in the ZTP failure, or a combination thereof.

12. The device of claim 9, wherein the DHCP message comprises a DHCPv4 Discover message or a DHCPv6 Solicit message.

13. The device of claim 9, wherein the one or more other devices or systems include a network management system (NMS).

14. The device of claim 13, wherein the instructions, when executed, further cause the one or more processors to provide at least a portion of the information to the NMS via a trap message in accordance with a prior configuration of the device by the NMS to monitor DHCP messages for information relating to ZTP failures.

15. The device of claim 13, wherein the instructions, when executed, further cause the one or more processors to provide at least a portion of the information to the NMS responsive to a command or a query received from the NMS.

16. The device of claim 9, wherein the one or more other devices or systems comprise a user device, and wherein the instructions, when executed, further cause the one or more processors to provide at least a portion of the information to the user device responsive to a user request received from the user device via a command line interface.

17. A non-transitory machine-readable medium, comprising executable instructions that, when executed by a processing system including a processor, facilitate performance of operations, the operations comprising:
at least one of
receiving a user command to query a device for information relating to one or more zero-touch provisioning (ZTP) failures, or
configuring the device to monitor Dynamic Host Configuration Protocol (DHCP) messages for the information; and
obtaining the information from the device based on the at least one of the receiving or the configuring.

18. The non-transitory machine-readable medium of claim 17, wherein the device comprises a DHCP Relay Agent (RA).

19. The non-transitory machine-readable medium of claim 17, wherein the processing system comprises a network management system (NMS).

20. The non-transitory machine-readable medium of claim 17, wherein the DHCP message comprises a DHCPv4 Discover message or a DHCPv6 Solicit message.
